(19) United States
(12) Patent Application Publication
(10) Pub. No.: US 2013/0026267 A1
(43) Pub. Date: Jan. 31, 2013

(54) MOVABLE METAL SEPARATOR

(71) Applicants: Gi-Young Roh, Busan (KR); Sun Hee Lee, Yongin-si (KR)

(72) Inventors: Gi-Young Roh, Busan (KR); Sun Hee Lee, Yongin-si (KR)

(73) Assignee: Gi-Young Roh, Busan (KR)

(21) Appl. No.: 13/504,240

(22) PCT Filed: Mar. 28, 2012
(86) PCT No.: PCT/KR2012/002238

§ 371 Date: Apr. 26, 2012

(30) Foreign Application Priority Data
Jul. 25, 2011 (KR) 10-2011-0073450
Oct. 10, 2011 (KR) 10-2011-0102941

(51) Int. Cl. B02C 23/02; B02C 23/04; B02C 15/00; B02C 23/14

(52) U.S. Cl. 241/37.5; 241/77

(57) ABSTRACT

The present invention provides a movable metal separator, including a base equipped with attachment/detachment means so that the base is detached from and attached to the loading box of a vehicle; feed means configured to convey a container containing separated matters in order to separate metals; a hopper configured to include transmission means installed on the side of the feed means and configured to filter the separated matters from the container that is turned over and a support configured to support the container that is turned over and thrown so that the container does not come in contact with the transmission means and configured to have a rubber layer formed on a surface thereof; a feed screw installed under the hopper and configured to convey the separated matters; a ball mill supplied with the separated matters from the hopper and configured to separate the metals by pulverizing metal substances; and a dust collector coupled to the ball mill and configured to filter dust generated in the ball mill. The metal separator can be carried and used at a desired place without being influenced by the time and space, and separated metal particles can be kept, stored, and conveyed more easily.

### TECHNICAL FIELD

The present invention relates to a movable metal separator and, more particularly, to a movable metal separator capable of rapidly performing a metal separation task irrespective of the time and space in such a manner that an apparatus capable of separating metals using a ball mill is mounted on a vehicle and then moved to a place where metals need to be separated. Furthermore, the present invention relates to a movable metal separator in which containers are automatically raised up and down to a hopper, thereby enabling a task to be performed conveniently, and the recovery of metals is performed at least twice on one side of the metal separator, thereby being capable of increasing space utilization.

### BACKGROUND ART

In general, in industries in which products are fabricated by processing metal materials, such as machine tools or extrusion molding apparatuses, after the products are processed, metal scraps, metal powder, etc. are generated. The metal scraps or powder, together with dust, are chiefly contained in a container using a vacuum cleaner, etc. and are then sent to a factory for reprocessing the metal scraps, the metal powder, and the dust.

The reprocessing factory is a long way off from an actual processing factory. The reprocessing factory receives separated matters to be reprocessed from each of the processing factories and separates metals by reprocessing the separated matters.

However, a conventional reprocessing method had the following problems.

1) Transport means for transporting separated matters to a reprocessing factory was required. In particular, a lot of time was consumed for the transportation because the transportation had to be performed between several processing factories and reprocessing factory.

2) A processing factory additionally required a space for keeping separated matters and lots of costs for maintenance because a certain amount of the separated matters had to be accumulated.

The execution of reprocessing processing at a desired place when needed was limited because a large-scale processing factory for processing separated matters was constructed.

### DISCLOSURE

### Technical Problem

The present invention has been made in view of the above problems, and an object of the present invention is to provide a movable metal separator configured to be movable so that the metal separator can be loaded on a vehicle and transported, whereby metals can be carried to a desired place and separated without being influenced by the time and space.

Furthermore, another object of the present invention is to provide a movable metal separator capable of more easily keeping, storing, and carrying separated metal particles by storing the separated metal particles using a bucket elevator.

Furthermore, yet another object of the present invention is to provide a movable metal separator further including a separator and a cyclone, which is capable of further increasing recycling efficiency by secondarily filtering metal particles from the remaining parts primarily granulated by a ball mill.

Furthermore, further yet another object of the present invention is to provide a movable metal separator including automatic lift means for automatically lifting up separated matters, in which a worker can perform a separation task by easily lifting up containers up to the inlet of a hopper even without additional equipment, such as a forklift truck, thereby being capable of improving work efficiency.

Furthermore, still yet another object of the present invention is to provide a movable metal separator configured to have separated matters, supplied to the hopper, directly supplied to the ball mill, thereby reducing the entire size of the movable metal separator while simplifying an overall construction of the movable metal separator and also being capable of improving separation efficiency while reducing the production cost.

Furthermore, further yet another object of the present invention is to provide a movable metal separator in which metals primarily separated by the ball mill are collected, metal particles collected by a separator, a cyclone, and a dust collector are secondarily collected, and containers for containing the primarily separated metals and the secondarily collected metal particles are placed on one side of the movable metal separator so that the movable metal separator may be mounted on one sidewall of a factory, etc. and then used, thereby being capable of minimizing a mounting space.

Finally, still yet another object of the present invention is provide a movable metal separator configured to have particles separated from atoms, discharged from the ball mill, through the separator and to have metal atoms removed from the remainder through the cyclone and the dust collector, while supplying the particles to the ball mill again so that even minute metal particles included in the air can be separated and collected one more, thereby being capable of further improving separation efficiency.

### Technical Solution

The movable metal separator according to the present invention for achieving the above object is as follows.

In an embodiment aspect of the present invention, there is provided a movable metal separator, including a base equipped with attachment/detachment means so that the base is detached from And attached to a loading box of a vehicle; feed means configured to convey a container containing separated matters in order to separate metals; a hopper configured to include transmission means installed on the side of the feed means and configured to filter the separated matters from the container that is turned over and a support configured to support the container that is turned over and thrown so that the container does not come in contact with the transmission means and configured to have a rubber layer formed on a surface thereof; a ball mill supplied with the separated matters from the hopper and configured to separate the metals by pulverizing metal substances; and a dust collector coupled to the ball mill and configured to filter dust generated in the ball mill.

In an embodiment aspect of the present invention, in particular, the base may further include out triggers at the respective corners of a bottom thereof so that a stably task is performed.

Furthermore, the attachment/detachment means is spacers received in and fixed to sprockets fixed to the loading box and configured to form an interval between the loading box and the base.

Furthermore, the feed means includes a plurality of rollers installed in parallel at predetermined intervals, wherein some of the rollers are formed to have a short length so that the container is easily turned over; a moving path formed along the rollers configured to allow a worker move safely; and steps providing guidance so that a worker goes up to the moving path.

Furthermore, the transmission means includes a grating made of metal material, formed in a frame shape of a picture frame form, and configured to have grids each 4 cm×4 cm on a top surface; and a discharge hole formed on the side of the frame and configured to discharge dust, generated therein, to a separator or a dust collector.

Furthermore, the ball mill includes throw amount control means provided on the exit side thereof and configured to control an amount of throw, and the throw amount control means includes a pair of guide rails mounted over and under the discharge hole of the ball mill; an adjustment plate configured to control the degree of opening of the ball mill while moving along the guide rails; and fixing means configured to fix the adjustment plate to the guide rails. Furthermore, the ball mill further includes a bucket lift for separating and packaging the separated metals on the exit side thereof. Furthermore, the ball mill further includes an air inflow path provided between the ball mill and the feed screw at a predetermined interval on the inlet side of the ball mill to which the feed screw is coupled. In particular, the air inflow path is formed to have an interval smaller than the diameter of a ball used in the ball mill.

The separator separates the metals, secondarily packages the metals, and supplies residues to the dust collector. A cyclone is further included between the dust collector and the separator.

In another embodiment aspect of the present invention, a movable metal separator includes a base equipped with attachment/detachment means so that the base is detached from and attached to the loading box of a vehicle; automatic elevation means installed in the base and configured to move up and down a container in order to separate metals; a hopper configured to include transmission means installed on the side of the automatic elevation means and configured to filter the separated matters from the container turned over by the automatic elevation means; a ball mill supplied with the separated matters from the hopper and configured to separate the metals by pulverizing metal substances; a separator configured to receive residues remained after the metals are separated from the ball mill and to supply the residues back to the ball mill; a cyclone coupled to the separator and configured to separate alien substances from the residues remained after the metals are separated; and a dust collector coupled to the cyclone and configured to filter dust.

The separated matters separated by the ball mill are primarily separated and packaged, and the separated matters separated by at least one of the dust collector, the separator, and the cyclone are secondarily separated and packaged, wherein package containers for the primary and secondary separations and packages are placed on one side of the movable metal separator.

In particular, the base further includes out triggers at the respective corners of a bottom thereof so that a stably task is performed.

Furthermore, the attachment/detachment means is spacers received in and fixed to sprockets fixed to the loading box and configured to form an interval between the loading box and the base.

Furthermore, the automatic elevation means includes a foot baseplate installed on the inlet side of the hopper; an elevation plate provided on the top of the automatic elevation means, equipped with a plurality of rollers at predetermined intervals so that the container is movable, and moved up and down in parallel to the foot baseplate; at least a pair of guides installed in parallel up and down at corner parts of the elevation plate; an actuator configured to enable the elevation plate to move up and down along the guides; and turn-over means installed on one side of the foot baseplate and configured to grasp and turn over the container raised up.

Here, the actuator includes a driving motor installed in the base and chain units fixed to the elevation plate and chain-driven by the driving motor or sheers members installed between the base and the elevation plate and a hydraulic or pneumatic cylinder for driving the sheers members.

Furthermore, the turn-over means includes a pivot installed so that the pivot is directed toward a center of the container; a forward/backward driving motor installed in the foot baseplate and configured to rotate the pivot; and a pair of sheers members installed at the end of the pivot so that the sheers members face each other and operated by respective cylinders in the opposite directions.

Meanwhile, the automatic elevation means further includes an auxiliary conveyer installed at a bottom so that the auxiliary conveyer is placed on a line extended from the plurality of rollers and configured to convey the containers.

Furthermore, the transmission means includes a grating made of metal material, formed in a frame shape of a picture frame form, and configured to have grids each 4 cm×4 cm on a top surface; and a discharge hole formed on the side of the frame and configured to discharge dust, generated therein, to a separator or a dust collector.

In particular, the ball mill includes throw amount control means provided on the exit side thereof and configured to control an amount of throw. The throw amount control means includes a pair of guide rails mounted over and under the discharge hole of the ball mill; an adjustment plate configured to control the degree of opening of the ball mill while moving along the guide rails; and fixing means configured to fix the adjustment plate to the guide rails. Furthermore, the ball mill further includes a bucket lift for separating and packaging the separated metals on the exit side thereof.

Furthermore, the ball mill further includes an air inflow path provided between the ball mill and the hopper at a predetermined interval on the inlet side of the ball mill to which the hopper is coupled.

### Advantageous Effects

The movable metal separator of the present invention has the following advantages:

1) Metal separation and operation can be easily performed because metals can be moved to any place using a vehicle and then separated.

2) Since the movable metal separator can be fabricated in a small size, separated matters can be easily processed even not only in a large-sized processing factory, but also in small and medium processing factories through a metal reparation request.

3) The movable metal separators having various processing capacities can be fabricated and used by determining the size of the metal separator based on a metal separation capacity.

4) Metal separation efficiency can be improved because metals can be secondarily separated and processed from the remaining dust, etc. included in primarily separated metals by using the separator and the cyclone further included the movable metal separator.

5) Keeping and storage are easy, and the containers for keeping metal particles can be easily carried and used because separated metal particles may be carried from the ball mill and then stored using the bucket elevator.

The movable metal separator according to another embodiment aspect of the present invention has the following advantages:

1) The number of workers can be reduced because separated matters can be supplied to the hopper by automatically lifting up the containers.

2) Accordingly, since additional lifting means, such as a forklift truck, needs not to be included, the movable metal separator can be easily maintained and repaired and work efficiency according to metal separation can be improved.

3) An overall construction of the movable metal separator can be simplified and the production cost can be reduced because separated matters are directly supplied to the ball mill by turning over the containers.

4) The containers for keeping metal particles obtained through primary and secondary separations are placed on one side of the movable metal separator. Accordingly, a mounting space can be reduced as compared with the case where the containers are placed left and right on the basis of the movable metal separator.

5) Metal recovery efficiency can be further increased because atoms discharged from the ball mill are separated by the separator, and metals separated from the atoms are recovered by the ball mill again and the remainder is recovered and recycled through the cyclone and the dust collector.

6) Metal recovery efficiency is increased as described above. Accordingly, a more eco-friendly movable metal separator can be provided because substances and metal particles included in the air and discharged through the dust collector can be reduced.

7) If metal, such as zinc harmful to the human body, is not properly recovered, not only the human body, but also an environment is subject to a harmful influence.

### DESCRIPTION OF DRAWINGS

FIG. 1 is an image of a perspective view showing an overall construction of a movable metal separator according to the present invention.

FIGS. 2A and 2B are images of a front view and a rear view showing the construction of the movable metal separator according to the present invention.

FIG. 3 is a partial perspective view of a base showing a state in which the base is mounted on a loading box according to the present invention.

FIG. 4 is an image of a perspective view illustrating the construction of feed means according to the present invention.

FIG. 5 is a perspective view showing the construction of transmission means according to the present invention.

FIGS. 6A and 6B are a perspective view and a sectional view showing the construction of adjustment means according to the present invention.

FIG. 7 is a sectional view showing a state in which a feed screw and a ball mill are coupled according to the present invention.

FIG. 8 is a perspective view showing a state in which the movable metal separator is mounted on a vehicle according to the present invention.

FIG. 9 is a perspective view showing a state in which the movable metal separator is used without being mounted on a vehicle according to the present invention.

FIGS. 10A and 10B are left and right side views of a state in which the movable metal separator is coupled according to the present invention.

FIG. 11 is a perspective view showing an overall construction of automatic elevation means according to the present invention.

FIG. 12 is a side view showing the overall construction of the automatic elevation means according to the present invention.

FIG. 13 is a perspective view showing the construction of turn-over means according to the present invention.

FIG. 14 is a sectional view showing a state in which a hopper and the ball mill are coupled according to the present invention.

FIG. 15 is a plan view, a front view, and a right side view of the movable metal separator according to the present invention.

FIG. 16 is a diagram showing the conveyer of the movable metal separator according to the present invention.

### BEST MODE

Preferred embodiments of the present invention are described in more detail below with reference to the accompanying drawings. Prior to the description, the terms or words used in the specification and the claims are not limited to or should not be construed as being typical or dictionary meanings, but should be construed as meanings and concepts which conform with the technical spirit of the present invention based on the principle that an inventor may properly define the concepts of the terms in order to describe his invention using the best method.

Accordingly, the embodiments described in this specification and the constructions shown in the drawings illustrate only the most preferred embodiments of the present invention and do not represent the entire technical spirit of the present invention. Accordingly, it should be understood that a variety of equivalent arrangements and modifications, which may replace the embodiments and the constructions may exist at the time of filing of this application.

<Construction>

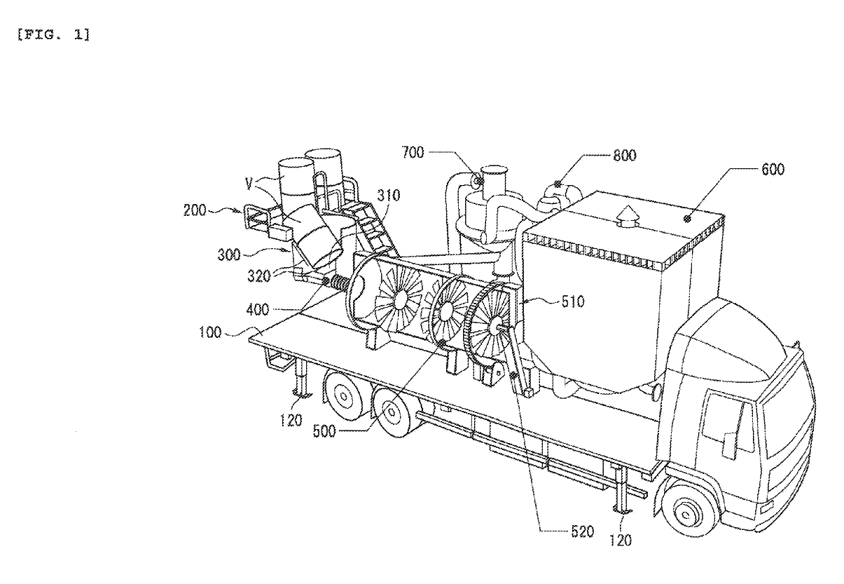

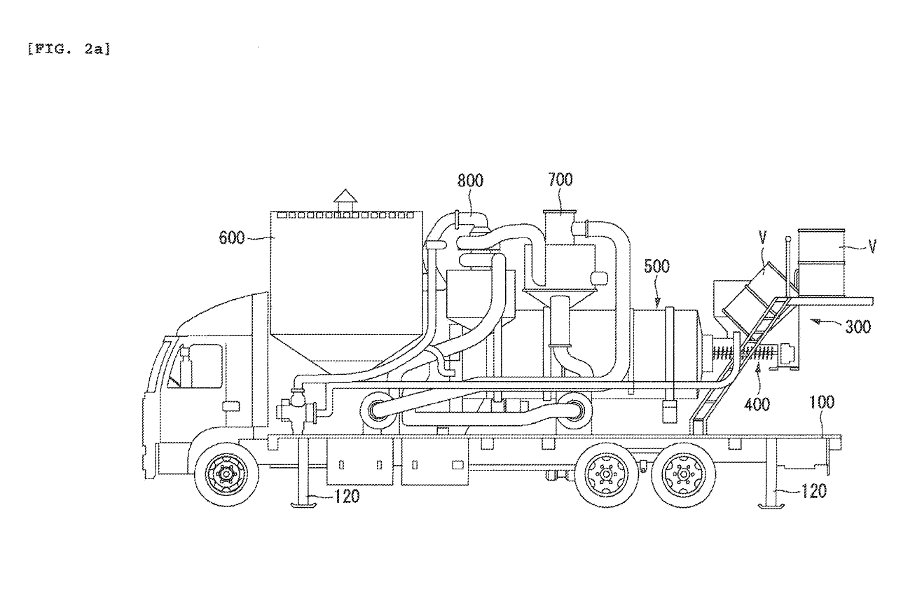

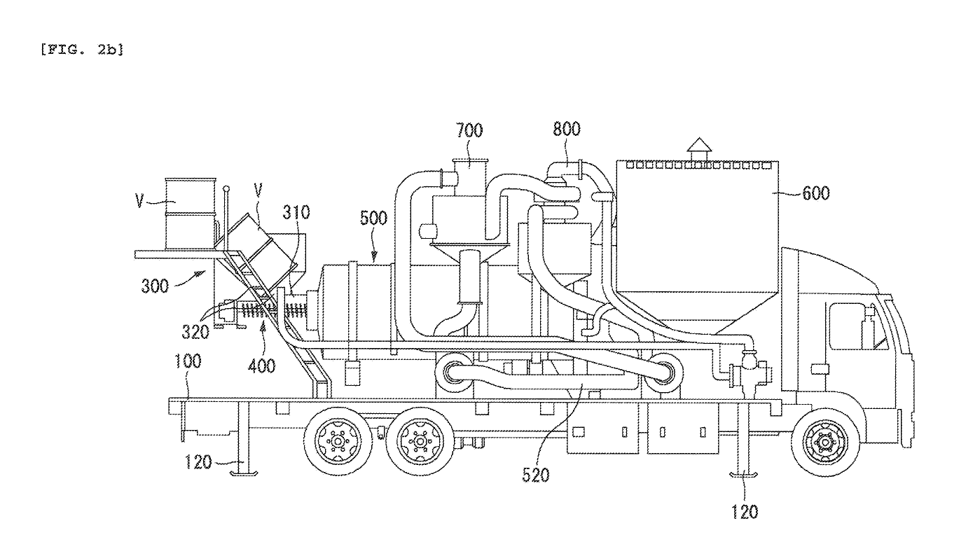

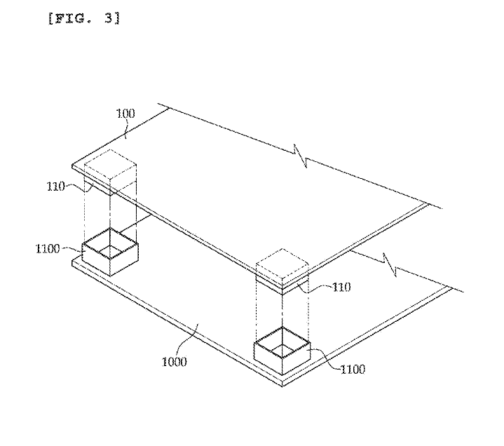

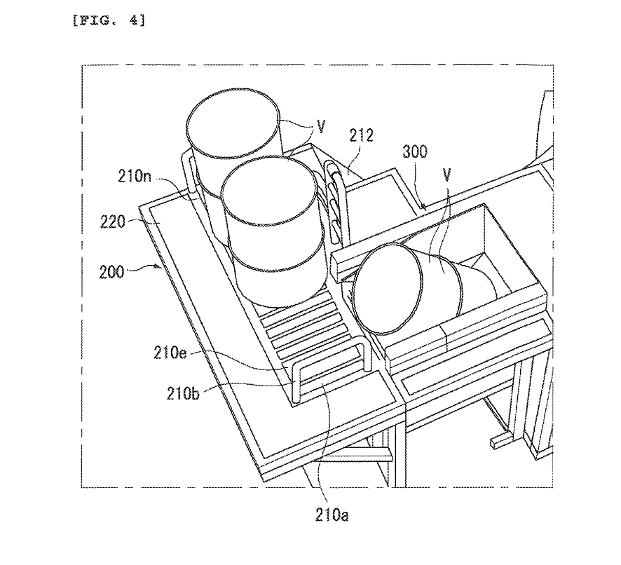

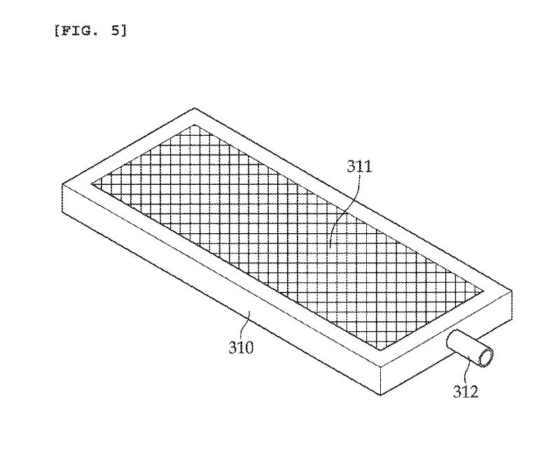

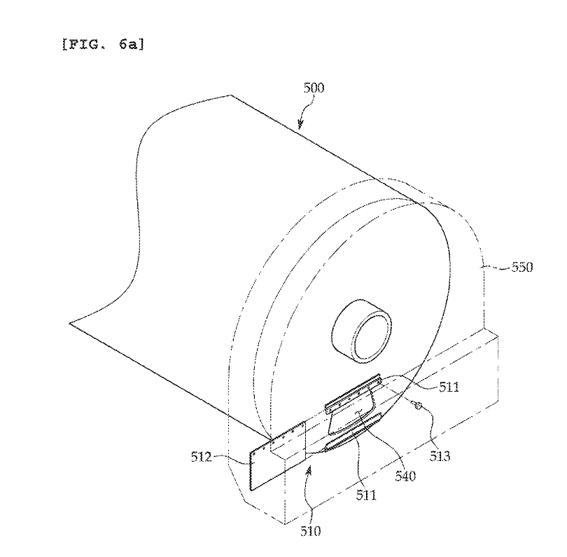

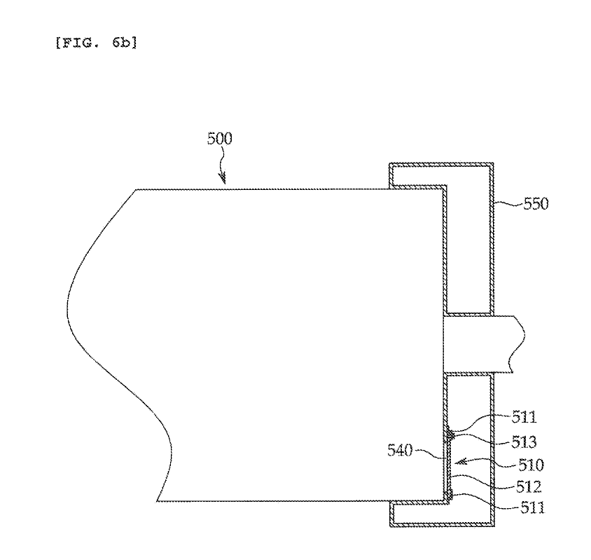

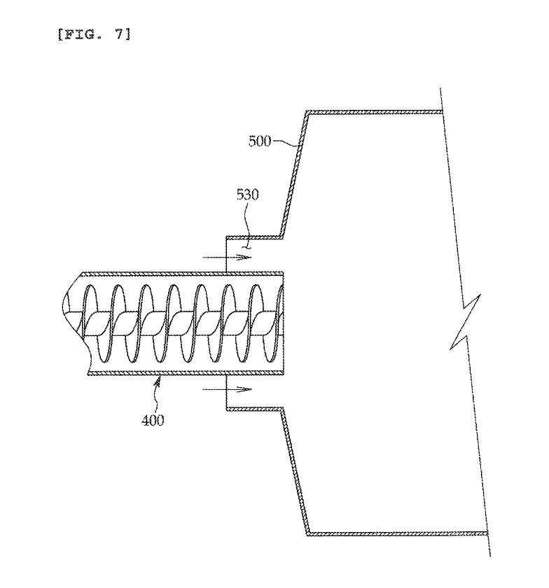

FIG. 1 is an image of a perspective view showing an overall construction of a movable metal separator according to the present invention, FIGS. 2A and 2B are images of a front view and a rear view showing the construction of the movable metal separator according to the present invention, FIG. 3 is a partial perspective view of a base showing a state in which the base is mounted on a loading box according to the present invention, FIG. 4 is an image of a perspective view illustrating the construction of feed means according to the present invention, and FIG. 5 is a perspective view showing the construction of transmission means according to the present invention. Furthermore, FIGS. 6A and 6B are a perspective view and a sectional view showing the construction of adjustment means according to the present invention, and FIG. 7 is a sectional view showing a state in which a feed screw and a ball mill are coupled according to the present invention. Here, reference numeral “1000” denotes the loading box of a vehicle, and “V” denotes a container for containing separated matters in which metal particles, dust, etc. are mixed and from which metals will be separated. Furthermore, the “separated matters” refer to chips generated by the processing process of a metal machine tool or a metal processing machine and metal scraps generated by extrusion forging, etc. which are collected in order to be reused along with dust, etc.

The movable metal separator according to the present invention includes a base 100 configured to have the movable metal separator detached from and attached to the loading box 1000 of a vehicle, feed means 200 mounted on the base 100 and configured to transfer the containers V, a hopper 300 configured to guide separated matters so that the separated matters can be thrown down from each of the containers V, a feed screw 400 configured to move the separated matters, transferred from the hopper 300, in a specific direction, a ball mill 500 configured to substantially separate metals from the transferred separated matters, and a dust collector 600 configured to filter toxic substances from the remaining mixture from which the metals have been separated by the ball mill 500.

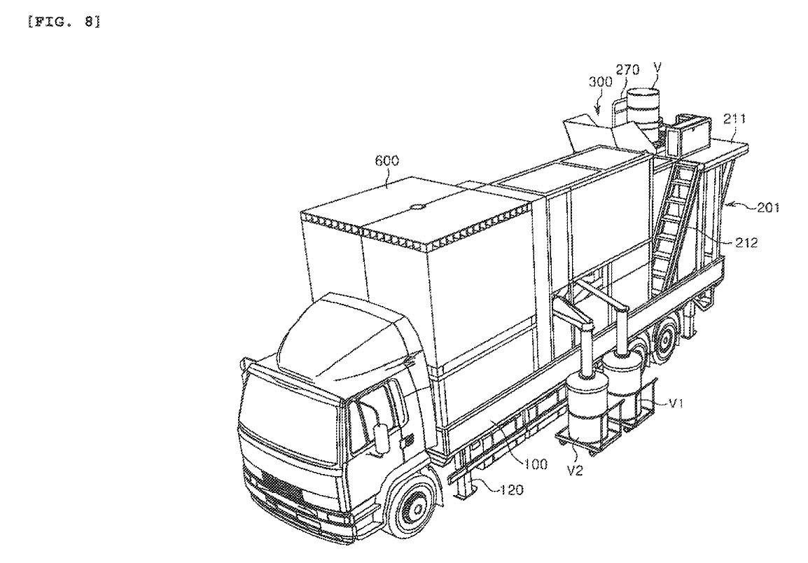

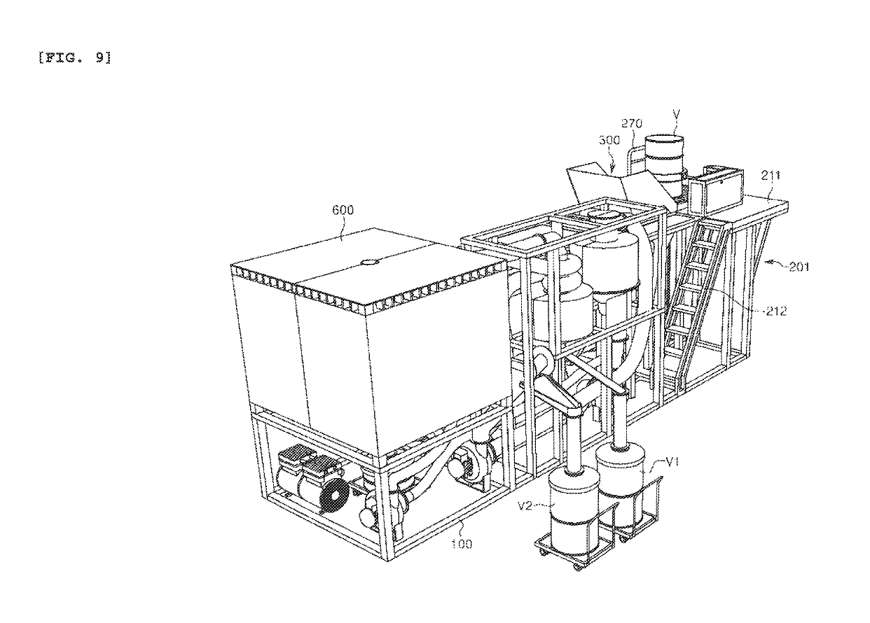

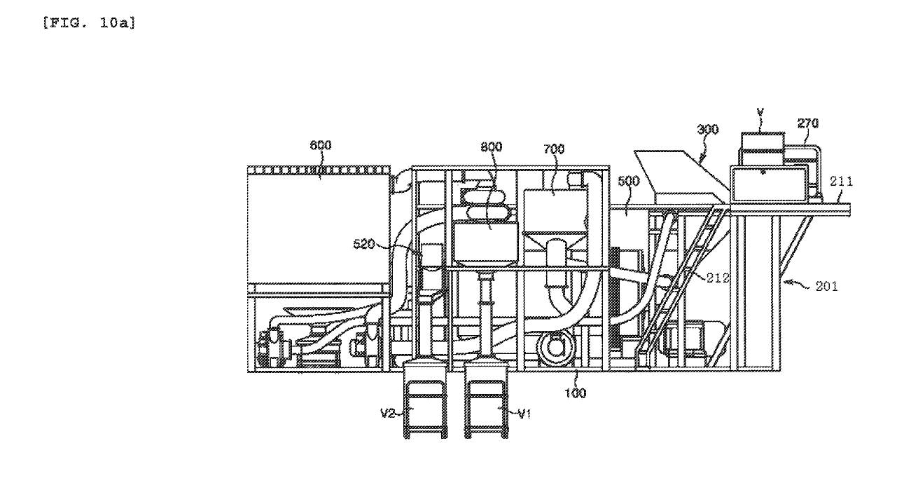

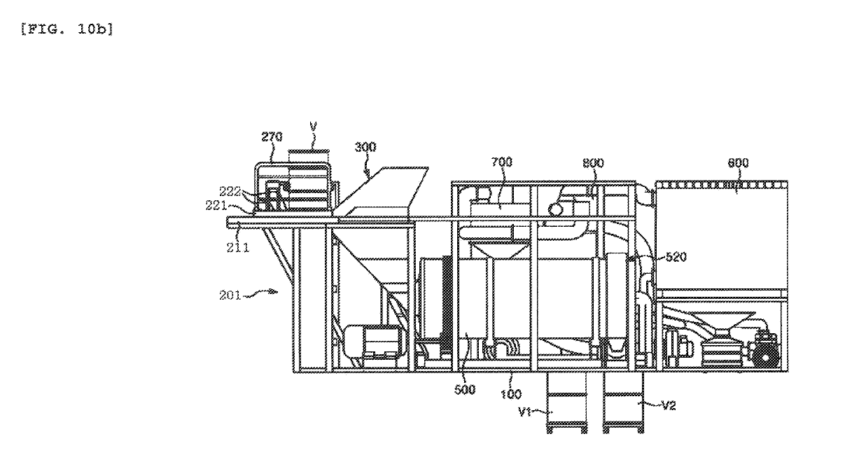

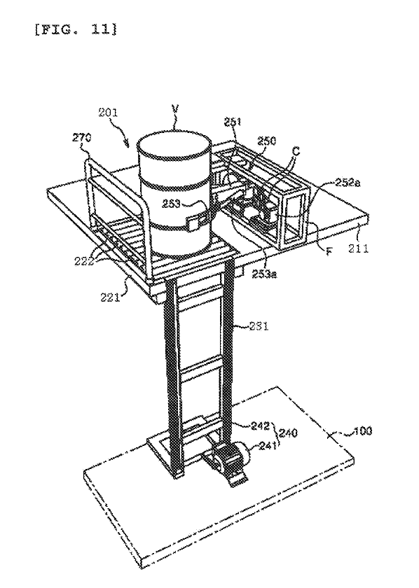

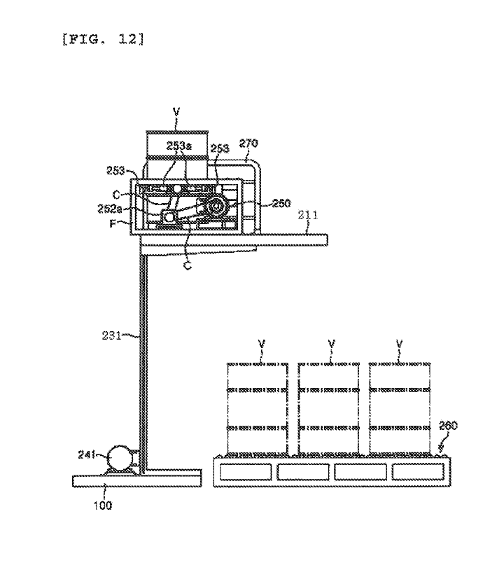

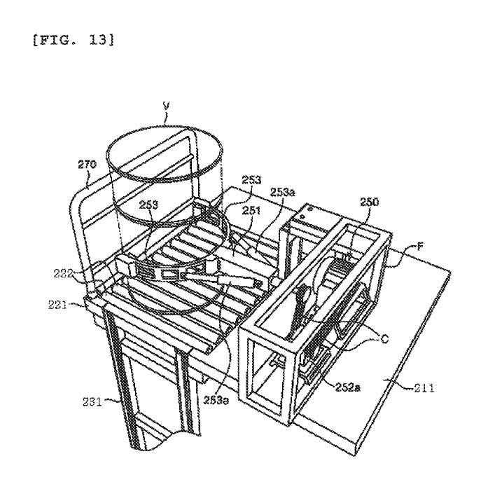

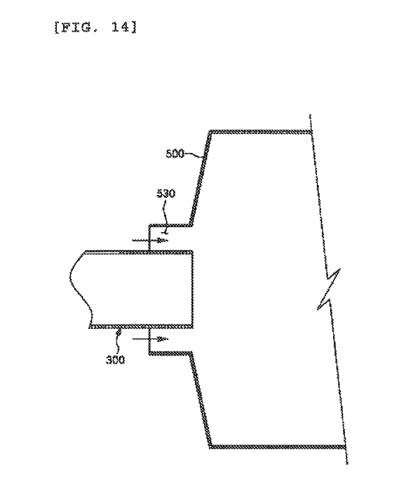

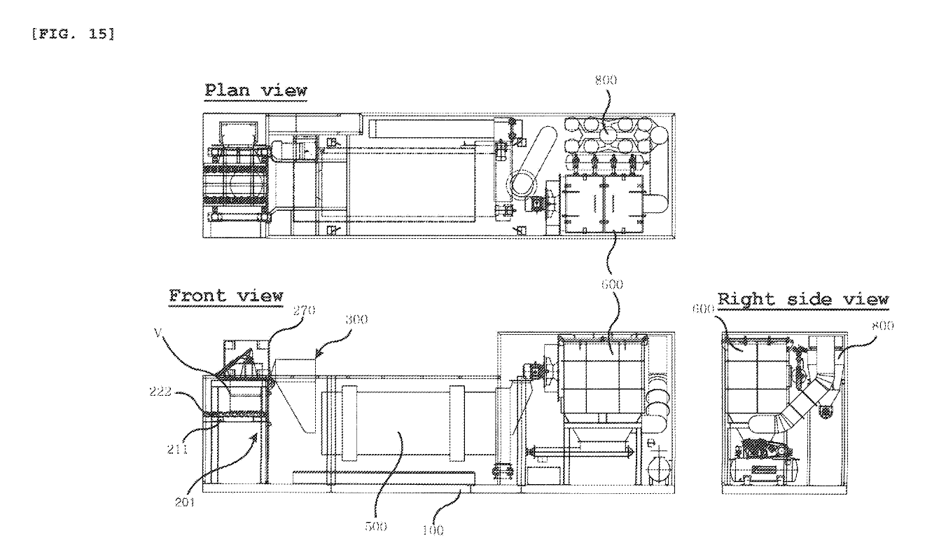

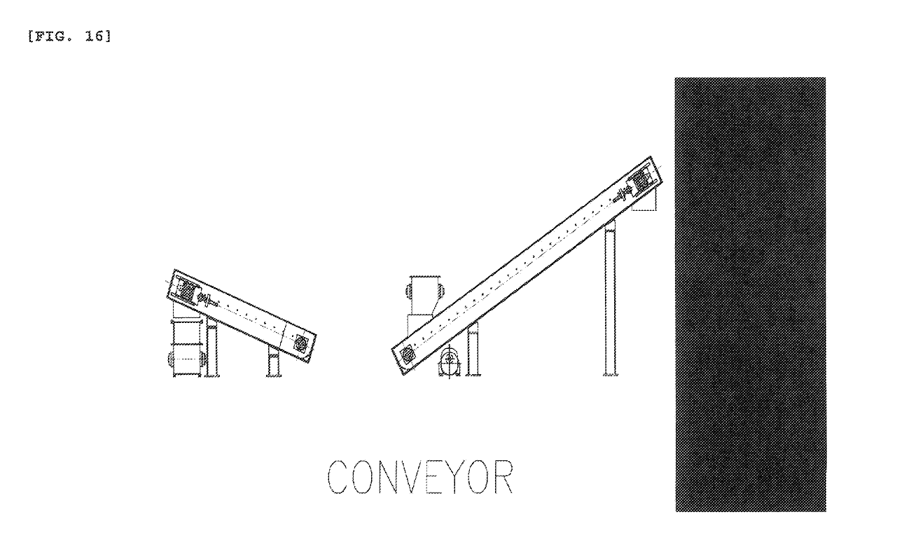

A movable metal separator according to another embodiment of the present invention, FIG. 8 is a perspective view showing a state in which the movable metal separator is mounted on a vehicle according to the present invention, FIG. 9 is a perspective view showing a state in which the movable metal Separator is used without being mounted on a vehicle according to the present invention, and FIGS. 10A and 10B are left and right side views of a state in which the movable metal separator is coupled according to the present invention. FIG. 3 is a partial perspective view of the base showing a state in which the base is mounted on the loading box according to the present invention, FIG. 11 is a perspective view showing an overall construction of automatic elevation means according to the present invention, and FIG. 12 is a side view showing the overall construction of the automatic elevation means according to the present invention. FIG. 13 is perspective view showing the construction of turn-over perspective view showing the construction of transmission means according to the present invention, and FIGS. 6A and 6B are a perspective view and a sectional view showing the construction of adjustment means according to the present invention. FIG. 14 is a sectional view showing a state in which a hopper and the ball mill are coupled according to the present invention. Here, reference numeral “1000” denotes the loading box of a vehicle, and “V” denotes the container for containing separated matters in which metal particles, dust, etc. are mixed and from which metals will be separated. Furthermore, the “separated matters” refer to chips generated by the processing process of a metal machine tool or a metal processing machine and metal scraps generated by extrusion forging, etc. which are collected in order to be reused along with dust, etc.

The movable metal separator according to another embodiment of the present invention includes a base 100 configured to have the movable metal separator detached from and attached to the loading box 1000 of a vehicle, automatic elevation means 201 mounted on the base 100 and configured to automatically raising and dropping a container V, a hopper 300 configured to guide separated matters so that the separated matters can be thrown down from each of the containers V by the automatic elevation means 201, a ball mill 500 configured to substantially separate metals from the separated matters supplied from the hopper 300, a separator 700 coupled to the ball mill 500 and configured to separate metals from atoms and to supply the metals back to the ball mill 500, a cyclone 800 coupled to the separator 700 and configured to separate metal substances from the residues remained after the metals are separated, and a dust collector 600 coupled to the cyclone 800 and configured to filter alien substances.

In particular, the movable metal separator according to the present invention primarily separates metals from the ball mill 500, packages the primarily separated metals, and secondarily separates and packages separated matters separated from at least one of the dust collector 600, the separator 700, and the cyclone 800.

Furthermore, package containers V1 and V2 for containing the primarily and secondarily separated and packaged matters are placed on one side of the movable metal separator.

### Mode for Invention

The elements of the movable metal separator are described in detail below.

The base 100 is fabricated to have a size so that the base 100 may be loaded on the loading box 1000 of a vehicle on which the movable metal separator according to the present invention is mounted. Furthermore, the base 100 is equipped with attachment/detachment means 110 for detachment from and attachment to the loading box 1000 as shown in FIG. 3.

The attachment/detachment means 110 is a spacer functioning as a kind of guide. It is preferred that four attachment/detachment means 110 be installed at the respective corners of a bottom of the base 100. Furthermore, the attachment/detachment means 110 is seated in and fixed to sprockets 1100 installed in the loading box 1000 in advance.

Here, each of the sprockets 1100 may have a rectangular container form having a top opened or may have a form having one side of a top opened so that the attachment/detachment means 110 may be inserted into the one side in its length direction. Furthermore, the attachment/detachment means 110 seated in the sprockets 1100 may be fixed using fixing means (not shown), such as fixing pins or fixing nuts, if there is a possibility that the attachment/detachment means 110 may be detached depending on a shape of the sprocket 1100.

The attachment/detachment means 110 installed as described above enables the base 100 to be spaced apart from the ground or the bottom of the loading box 1000 at a specific interval so that the base 100 may be moved to a desired place using a forklift truck and then used. The base 100 may further include fixing rings (not shown) at positions corresponding to the attachment/detachment means 110 or at peripheries thereof, so that the movable metal separator according to the present invention may be detached from and attached to a vehicle using a crane, etc.

Meanwhile, out triggers 120 may be further included at the respective corners of the bottom of the base 100, as shown in FIGS. 1, 2A, and 2B. The out triggers 120 are configured to distribute the load of a vehicle body and to guarantee, a safe work in expensive equipment, etc. Common out triggers may be used as the out triggers 120.

Furthermore, the out triggers 120 are illustrated as being installed in the base 100, but the out triggers 120 may not be further included if out triggers are already mounted on a vehicle.

The feed means 200 is an element for sequentially moving the containers V to the hopper 300 and then turning over the containers V so that the separated matters can be supplied to the hopper 300.

The feed means 200, as shown in FIG. 4, includes a plurality of rollers 210a to 210n for substantially transferring the containers V and a moving path 220 and steps 212 for enabling a worker to go up and safely work.

In particular, a plurality of the containers V may be consecutively transferred on the rollers 210a to 210n. Some of the rollers 210a to 210n are fabricated to have a short length. That is, the plurality of containers V is transferred in parallel on the rollers 210a to 210n. From among them, the container V that is transferred first of all is placed in front of the hopper 300. In this case, the rollers 210a, 210b, and 210c that support the container V are fabricated to have a short length so that a worker may enter the hopper 300 while turning over the container V. Accordingly, when a worker pushes the container V on the other side, where the container V is not supported (i.e., on the moving path (220) side), the container V is easily fallen and turned over. Furthermore, the container V is loaded on the rollers 210a to 210n by using a forklift truck, etc.

Furthermore, the moving path 220 is formed in parallel to a direction where the container V travels. In this case, a worker may prevent the container V from being erroneously transferred and detached, while walking along the moving path 220.

Finally, the steps 212 enable a worker to easily go up and down the moving path 220 because of a height difference between the base 100 and the moving path 220.

The hopper 300 is installed on the side of the feed means 200, and it supports the container V that is fallen and turned over and transfers the separated matters, discharged from the container V, to the feed screw 400. Furthermore, the hopper 300 is equipped with transmission means 310 for enabling the separated matters of a specific size to be supplied to the feed screw 400.

The transmission means 310 has a frame shape of a picture frame form as shown in FIG. 5. In particular, a grating 311 made of metal material is included at the top of the transmission means 310. The grating 311 has grids through which only a separated matter having a specific size (e.g., about 4 cm×4 (cm) can pass. The size of the grid may be different depending on the size of a separated matter that may be processed by the ball mill 500, but not limited thereto. Furthermore, a worker crushes separated matters, not passing through the grating 311, by using a worktable, etc. so that the crushed matters can pass through the grating 311.

Furthermore, a discharge hole 312 is formed on the side of the frame of the transmission means 310. The discharge hole 312 is coupled to the dust collector 600 or the separator 700 to be described later. Dust is generated when the container V is turned over within the hopper 300. The discharge hole 312 functions to remove the dust and collect metal powder included in the dust again.

Meanwhile, the hopper 300 is equipped with a support 320 for supporting a turned-over container V as shown in FIGS. 1 and 2B. In particular, it is preferred that rubber, etc. be coated on a surface of the support 320 in order to minimize an impact applied from the container V to the metal separator.

In a preferred embodiment of the present invention, it is preferred that three supports 320 be installed within the hopper 300. A pair of two of the supports 320 are installed right over the transmission means 310 and are mounted in parallel to the direction where the container V travels, thus supporting a lower corner part of the container V that is turned over. Furthermore, the remaining one of the three supports 320 is installed in the inside middle part of the hopper 300 in order to prevent the container V, turned over, from directly applying an impact to the inside of the hopper 300.

The feed screw 400 is used to mix or pulverize raw materials by employing the rotation of the screw, and a common feed screw is used as the feed screw 400.

The ball mill 500 has balls included therein and produces metal powder by colliding metals, included in the separated matters, against the balls while the ball mill 500 is rotated. A common ball mill is used as the ball mill 500. In particular, adjustment means 510 for adjusting the amount of metal powder produced after processing when the metal powder is externally discharged is provided on the exit side of the ball mill 500.

The adjustment means 510 includes guide rails 511 formed on both sides of a discharge hole 540 formed on the exit face of the ball mill 500, an adjustment plate 512 inserted between the guide rails 511 and configured to control the degree of opening of the discharge hole 540, and fixing means 513 configured to fix the adjustment plate 512 to the guide rails 511, as shown in FIGS. 6A and 6B. Here, a bolt and a nut or a pin, such as a separation pin, may be used as the fixing means 513. In the drawing, reference numeral “550” not described denotes a support bucket for supporting the ball mill 500 and collecting metal powder discharged from the discharge hole 540. The support bucket 550 may further include an outlet for manually discharging metal powder outside the metal separator.

In a preferred embodiment of the present invention, the ball mill 500 may further include a bucket lift 520, as shown in FIGS. 1 and 2B. The plurality buckets of the bucket lift 520 is rotated in the form of an endless track along a specific track, thereby carrying metal powder using the bucket. The bucket lift 520 is installed within the support bucket 550 and is configured to lift up metal powder using the support bucket to a specific height so that the metal power can be packaged in a new container. Accordingly, work efficiency can be improved.

The bucket lift 520 is useful when the metal separator according to the present invention is detached from a vehicle and then used on the ground. In other words, when the base 100 comes in contact with the bottom, etc. of a factory, the support bucket 550 also almost comes in contact with the bottom of the factory, thereby making it difficult to process metal powder. For this reason, when the metal powder is lifted, up to a specific height or more using the bucket lift 520 and then automatically received in the container, work efficiency can also be improved.

Furthermore, in a preferred embodiment of the present invention, an air inflow path 530 may be further formed in the ball mill 500 on the inlet side of the ball mill 500 coupled to the feed screw 400, as shown in FIG. 7. Minute dust is filtered from dust generated in the ball mill 500 and externally discharged by using the dust collector 600. In this case, the air inflow path 530 functions to prevent vacuum from being generated within the ball mill 500 when the minute dust is externally discharged.

In particular, the interval of the air inflow path 530 between the housing of the ball mill 500 and the outside of the feed screw 400 has to be smaller than the diameter of a ball used in the ball mill 500. This is because, if the interval of the air inflow path 530 is greater than the diameter of the ball, the balls may be discharged outside the ball mill 500 through the air inflow path 530 when the ball mill 500 is operated. It may lead to casualties and function to deteriorate work efficiency due to the reduced number of balls.

The dust collector 600 is coupled to the ball mill 500, and it functions to receive dust generated therein and filter toxic alien substances from the dust. The dust collector 600 may further include a fan in order to increase an effect that dust, etc. are introduced.

The dust collector 600 has a construction widely known in the art, and thus a detailed description thereof is omitted.

Furthermore, it is preferred that the dust collector 600 be also coupled to the discharge hole 312 so that alien substances formed in the transmission means 310 are also processed.

Meanwhile, the movable metal separator according to the present invention may further include the separator 700 and the cyclone 800 in order to further increase the recycling effect of metal powder, as shown in FIGS. 1, 2A, and 2B. The separator 700 is installed between the ball mill 500 and the dust collector 600, and it functions to filter metal powder, included in dust generated in the ball mill 500, one more.

The movable metal separator according to the present invention may recycle secondary metal powder, separated by the separator 700, along with primary metal powder that is generated from the ball mill 500 and then discharged to the discharge hole 540.

In this case, the cyclone 800 is installed between the dust collector 600 and the separator 700. The cyclone 800, more effectively filters toxic alien substances from dust, etc. that are discharged from the separator 700, thereby being capable of increasing an air pollution prevention effect.

Furthermore, in a preferred embodiment of the present invention, the movable metal separator according to the present invention may further include a movable electric generator. The movable electric generator supplies a power source necessary for the metal separator according to the present invention. A common power source used in a factory is typically used as the power source for the metal separator. If a power source used in a factory is not sufficient or may not be used, however, the movable electric generator supplies a necessary power source to the movable metal separator according to the present invention.

In a movable metal separator according to yet another embodiment of the present invention, the base 100 is fabricated to have a size where the base 100 may be loaded on the loading box 1000 of a vehicle on which the movable metal separator according to the present invention is mounted. The base 100 is further equipped with the attachment/detachment means 110 for attaching or detaching the loading box 1000, as shown in FIG. 3.

The attachment/detachment means 110 is a spacer functioning as a kind of guide. It is preferred that four attachment/detachment means 110 be installed at the respective corners of a bottom of the base 100. Furthermore, the attachment/detachment means 110 is seated in and fixed to sprockets 1100 installed in the loading box 1000 in advance.

Here, each of the sprockets 1100 may have a rectangular container form having a top opened or may have a form having one side of a top opened so that the attachment/detachment means 110 may be inserted into the one side in its length direction. Furthermore, the attachment/detachment means 110 seated in the sprockets 1100 may be fixed using fixing means (not shown), such as fixing pins or fixing nuts, if there is a possibility that the attachment/detachment means 110 may be detached depending on a shape of the sprocket 1100.

The attachment/detachment means 110 installed as described above enables the base 100 to be spaced apart from the ground or the bottom of the loading box 1000 at a specific interval so that the base 100 may be moved to a desired place using a forklift truck and then used. The base 100 may further include fixing rings (not shown) at positions corresponding to the attachment/detachment means 110 or at peripheries thereof, so that the movable metal separator according to the present invention may be detached from and attached to a vehicle, using a crane, etc.

Meanwhile, out triggers 120 may be further included at the respective corners of the bottom of the base 100, as shown in FIGS. 1, 2A, and 2B. The out triggers 120 are configured to distribute the load of a vehicle body and to guarantee, a safe work in expensive equipment, etc. Common out triggers may be used as the out triggers 120.

Furthermore, the out triggers 120 are illustrated as being installed in the base 100, but the out triggers 120 may not be further included if out triggers are already mounted on a vehicle.

The automatic elevation means 201 includes a foot baseplate 211 installed on the inlet side of the hopper 300, an elevation plate 221 configured to move up and down between the foot baseplate 211 and the base 100, guides 231 configured to guide the elevation plate 221, an actuator 240 configured to substantially move up and down the elevation plate 221, and turn-over means 250 configured to turn over the container V.

The foot baseplate 211 is a kind of footplate that enables a worker to go up, see a work situation, etc., and control an elevation action, a turn-over operation, etc. The foot baseplate 211 is equipped with the steps 212 as shown in FIGS. 8 to 10 so that a worker can go up to the foot baseplate 211.

The elevation plate 221 is an element for supporting the container V. In particular, a plurality of rollers 222 is provided at the top of the elevation plate 221 at predetermined intervals. Here, the plurality of rollers 222 may be automatically rotated and may be configured so that the container V is manually pushed and then used. In the drawing, reference numeral “270” not described denotes a safety bar mounted on the elevation plate 221 and configured to support the container V so that the container V does not fall.

The guides 231 are installed between the base 100 and the foot baseplate 211 and are configured to guide the elevation plate 221 so that the elevation plate 221 can move up and down. It is preferred that the guides 231 be provided at the respective corners of the elevation plate 221 so that safe guidance can be provided. In FIG. 12, a pair of the guides 231 are illustrated as being formed at the respective corners on one side, but it is preferred that another pair of the guides 231 be provided at the opposite position for a more safe elevation action.

The actuator 240 provides operation force necessary to move up and down the elevation plate 221. The actuator 240 may include, for example, a driving motor 241 mounted on the base 100 and chain units 242 chain-driven by the driving motor 241 and fixed to the elevation plate 221. Furthermore, the actuator 240 may be configured to move up and down the elevation plate 221 using sheers members of an “X” shape so that the sheers member are operated by a hydraulic or pneumatic cylinder.

The turn-over means 250 includes a forward/backward driving motor 252 installed on the foot baseplate 211, a pivot 251 rotated by the forward/backward driving motor 252, and sheers members 253 configured to fix the container V.

The pivot 251 is installed on the side of the container V so that it is directed toward the center of the container V. Here, the pivot 251 is installed in such a way as to be stably rotated by using a frame F. In particular, it is preferred that the pivot 251 be mounted on a place where the sheers members 253 can be moved up and down.

The forward/backward driving motor 252 is a motor for rotating the pivot 251 in the forward and backward directions. The forward/backward driving motor 252 may further include a decelerator 252a for controlling the number of rotations. It is preferred that the forward/backward driving motor 252 use a driving method using a chain C for the purpose of the stable operation of the pivot 251.

A pair of the sheers members 253 are installed at the end of the pivot 251 so that they face each other and are formed to have a similar section as the container V. That is, each of the sheers members 253 is formed in a semi-circle form because the container V having a circular section is chiefly used. It is preferred that the pair of sheers members 253 be formed to surround the container V. Furthermore, the sheers members 253 are operated by respective cylinders 253a. In particular, the cylinders 253a drive the respective sheers members 253 in opposite directions.

The turn-over means 250 constructed as above is operated in the state in which the container V has moved until the center of the container V is placed on the axial line of the pivot 250 along the elevation plate 221 in the state in which the sheers members 253 are widened to the highest degree so that they do not come in contact with the container V. First, the cylinders 253a are operated so that the sheers members 253 turn over the container V, and the forward/backward driving motor 252 is then driven to rotate the pivot 251, so that the container V is turned over.

Meanwhile, the automatic elevation means 201 according to the present invention further include an auxiliary conveyer 260. The auxiliary conveyer 260 is installed on a line extended from the base 100 or on the base 100. Preferably, when the elevation plate 221 is placed at the lowest position, the auxiliary conveyer 260 is placed on the extension line. Accordingly, the auxiliary conveyer 260 provides guidance so that the plurality of containers V can be easily conveyed on the elevation plate 221.

The auxiliary conveyer 260 may be configured to automatically convey the containers V and may be configured so that the containers V are manually conveyed using the plurality of rollers 222.

The hopper 300 supplies the separated matters, discharged from the container V turned over by the automatic elevation means 201, to the ball mill 500. Furthermore, the hopper 300 is equipped with the transmission means 310 so that separated matters each having a specific size can be supplied to the ball mill 500.

The transmission means 310 has the frame shape of a picture frame form as shown in FIG. 5. In particular, the grating 311 made of metal material is included at the top of the transmission means 310. The grating 311 has grids through which only a separated matter having a specific size (e.g., about 4 cm×4 cm) can pass. The size of the grid may be different depending on the size of a separated matter that may be processed by the ball mill 500, but not limited thereto. Furthermore, a worker crushes separated matters, not passing through the grating 311, by using a worktable, etc. so that the crushed matters can pass through the grating 311.

Furthermore, the discharge hole 312 is formed on the side of the frame of the transmission means 310. The discharge hole 312 is coupled to the dust collector 600 or the separator 700 to be described later. Dust is generated when the container V is turned over within the hopper 300. The discharge hole 312 functions to remove the dust and collect metal powder included in the dust again.

The ball mill 500 has balls included therein and produces metal powder by colliding metals, included in the separated matters, against the balls while the ball mill 500 is rotated. A common ball mill is used as the ball mill 500. In particular, adjustment means 510 for adjusting the amount of metal powder produced after processing when the metal powder is externally discharged is provided on the exit side of the ball mill 500.

The adjustment means 510 includes the guide rails 511 formed on both sides of the discharge hole 540 formed on the exit face of the ball mill 500, the adjustment plate 512 inserted between the guide rails 511 and configured to control the degree of opening of the discharge hole 540, and the fixing means 513 configured to fix the adjustment plate 512 to the guide rails 511, as shown in FIGS. 6A and 6B. Here, a bolt and a nut or a pin, such as a separation pin, may be used as the fixing means 513. In the drawing, reference numeral “550” not described denotes the support bucket for supporting the ball mill 500 and collecting metal powder discharged from the discharge hole 540. The support bucket 550 may further include an outlet for manually discharging metal powder outside the metal separator.

In a preferred embodiment of the present invention, the ball mill 500 may further include the bucket lift 520, as shown in FIG. 10A. The plurality of buckets of the bucket lift 520 is rotated in the form of an endless track along a specific track, thereby carrying metal powder using the bucket. The bucket lift 520 is installed within the support bucket 550 and is configured to lift up metal powder using the support bucket to a specific height so that the metal power can be packaged in a new container. Accordingly, work efficiency can be improved.

The bucket lift 520 is useful when the metal separator according to the present invention is detached from a vehicle and then used on the ground. In other words, when the base 100 comes in contact with the bottom, etc. of a factory, the support bucket 550 also almost comes in contact with the bottom of the factory, thereby making it difficult to process metal powder. For this reason, when the metal powder is lifted up to a specific height or more using the bucket lift 520 and then automatically received in the container, work efficiency can also be improved.

The metal powder separated by the ball mill 500 as described above is contained in the package container V1 through one side of the movable metal separator of the present invention as shown in FIG. 10A.

Furthermore, in a preferred embodiment of the present invention, the ball mill 500 may further include the air inflow path 530 on the inlet side coupled to the hopper 300 as shown in FIG. 14. Minute dust is filtered from dust generated in the ball mill 500 and externally discharged by using the dust collector 600. In this case, the air inflow path 530 functions to prevent vacuum from being generated within the ball mill 500 when the minute dust is externally discharged.

In particular, the interval of the air inflow path 530 between the housing of the ball mill 500 and, the outside of the hopper 300 has to be smaller than the diameter of a ball used in the ball mill 500. This is because, if the interval of the air inflow path 530 is greater than the diameter of the ball, the balls may be discharged outside the ball mill 500 through the air inflow path 530 when the ball mill 500 is operated. It may lead to casualties and function to deteriorate work efficiency due to the reduced number of balls.

The separator 700 is an element coupled to the ball mill 500 and configured to separate particles and residues thereof from each other. A common separator is used as the separator 700. In particular, since the particles include metal particles, the metal particles are supplied to the ball mill 500 again so that they can be packaged. The remaining air and other impurities are sent to the cyclone 800.

In a preferred embodiment of the present invention, the metal particles separated by the separator 700 are illustrated as being supplied to the ball mill 500, but the metal particles may be directly supplied to the secondary package container V2.

The cyclone 800 receives air, etc. filtered by the separator 700, collects the remaining minute particles from air, etc, and discharges the remainder to the dust collector 600. The cyclone 800 filters toxic alien substances from dust, etc. that are discharged from the separator 700 more effectively, thereby increasing an air pollution prevention effect.

The dust collector 600 is coupled to the cyclone 800, and it functions to receive dust generated therein, filter toxic alien substances from the dust, and discharge only clean air to the outside. The dust collector 600 may further include a fan in order to increase an effect that dust, etc. are introduced. The construction of the dust collector 600 has already been known in the art, and thus a detailed description thereof is omitted.

It is also preferred that the dust collector 600 be also coupled to the discharge hole 312 so that alien substances formed in the transmission means 310 can be processed.

Meanwhile, in a preferred embodiment of the present invention, it is preferred that separated matters separated by at least one of the dust collector 600, the separator 700, and the cyclone 800 be secondarily separated and packaged in the package container V2 so that metal particles contained in the secondary package container V2 can be recycled.

Furthermore, the secondary package container V2 is constructed in the movable metal separator so that it is placed on the same side as the primary package container V1 as shown in FIGS. 8 to 10B, thereby being capable of minimizing a maximum size of the movable metal separator according to the present invention.

### DESCRIPTION OF REFERENCE NUMERAL

100: base
110: attachment/detachment means
120: out triggers
200: feed means
201: automatic elevation means
210a to 210n: roller
211: foot baseplate
212: step
220: moving path
221: elevation plate
222: plurality of rollers
231: guide
241: driving motor
242: chain unit
250: turn-over means
251: pivot
252: forward/backward driving motor
252a: decelerator
253: sheers member
253a: cylinder
260: auxiliary conveyer
300: hopper
310: transmission means
311: grating
312: discharge hole
320: support
400: feed screw
500: ball mill
510: adjustment means
511: guide rail
512: adjustment plate
513: fixing means
520: bucket lift
530: air inflow path
540: discharge hole
550: support bucket
600: dust collector
700: separator
800: cyclone

### INDUSTRIAL APPLICABILITY

As described above, according to the present invention, the movable metal separator is constructed so that it may be loaded on a vehicle, etc. and then used. Accordingly, metal separation and processing can be performed right at a desired place without being limited to the time and space. Furthermore, since the container can be automatically moved up and down, not only a separation task can be automated, but also the degree of recycling of metals can be increased through twice separations and packages.

1. A movable metal separator, comprising:
a base equipped with attachment/detachment means so that the base is detached from and attached to a loading box of a vehicle;
feed means configured to convey a container V containing separated matters in order to separate metals;
a hopper configured to include transmission means installed on a side of the feed means and configured to filter the separated matters from the container V that is turned over and a support configured to support the container V that is turned over and thrown so that the container V does not come in contact with the transmission means and configured to have a rubber layer formed on a surface thereof;
a ball mill supplied with the separated matters from the hopper and configured to separate the metals by pulverizing metal substances; and
a dust collector coupled to the ball mill and configured to filter dust generated in the ball mill.

2. The movable metal separator method according to claim 1, further comprising a feed screw installed under the hopper and configured to convey the separated matters, wherein the ball mill is installed in parallel to the feed screw.

3. The movable metal separator method according to claim 1, wherein the feed means comprises:
a plurality of rollers installed in parallel at predetermined intervals, wherein some of the rollers are formed to have a short length so that the container V is easily turned over;
a moving path formed along the rollers configured to allow a worker move safely; and
steps providing guidance so that a worker goes up to the moving path.

4. The movable metal separator method according to claim 1, wherein the feed means is automatic elevation means.

5. The movable metal separator method according to claim 1, wherein the base further comprises out triggers at respective corners of a bottom thereof so that a stably task is performed.

6. The movable metal separator method according to claim 1, wherein the attachment/detachment means is spacers received in and fixed to sprockets fixed to the loading box and configured to form an interval between the loading box and the base.

7. The movable metal separator method according to claim 1, wherein the transmission means comprises:
a grating made of metal material, formed in a frame shape of a picture frame form, and configured to have grids each 4 cm×4 cm on a top surface; and
a discharge hole formed on a side of the frame and configured to discharge dust, generated therein, to a separator or a dust collector.

8. The movable metal separator method according to claim 1, wherein:
the ball mill comprises throw amount control means provided on an exit side thereof and configured to control an amount of throw, and
the throw amount control means comprises:
a pair of guide rails mounted over and under a discharge hole of the ball mill;
an adjustment plate configured to control a degree of opening of the ball mill while moving along the guide rails; and
fixing means configured to fix the adjustment plate to the guide rails.

9. The movable metal separator method according to claim 8, wherein the ball mill further comprises a bucket lift for separating and packaging the separated metals on an exit side thereof.

10. The movable metal separator method according to claim 9, wherein the ball mill further comprises an air inflow path provided between the ball mill and the feed screw at a predetermined interval on an inlet side of the ball mill to which the feed screw is coupled.

11. The movable metal separator method according to claim 10, wherein the air inflow path is formed to have an interval smaller than a diameter of a ball used in the ball mill.

12. The movable metal separator method according to claim 1, further comprising a separator between the ball mill and the dust collector, wherein the separator separates the metals, secondarily packages the metals, and supplies residues to the dust collector.

13. The movable metal separator method according to claim 12, further comprising a cyclone between the dust collector and the separator.

14. A movable metal separator, comprising:
a base equipped with attachment/detachment means so that the base is detached from and attached to a loading box of a vehicle;
automatic elevation means installed in the base and configured to move up and down a container V in order to separate metals;
a hopper configured to include transmission means installed on a side of the automatic elevation means and configured to filter the separated matters from the container V turned over by the automatic elevation means;
a ball mill supplied with the separated matters from the hopper and configured to separate the metals by pulverizing metal substances;
a separator configured to receive residues remained after the metals are separated from the ball mill and to supply the residues back to the ball mill;
a cyclone coupled to the separator and configured to separate alien substances from the residues remained after the metals are separated; and
a dust collector coupled to the cyclone and configured to filter dust,
wherein the separated matters separated by the ball mill are primarily separated and packaged, and the separated matters separated by at least one of the dust collector, the separator, and the cyclone are secondarily separated and packaged, wherein package containers for the primary and secondary separations and packages are placed on one side of the movable metal separator.

15. The movable metal separator method according to claim 14, wherein the automatic elevation means comprises:
a foot baseplate installed on an inlet side of the hopper;
an elevation plate provided on a top of the automatic elevation means, equipped with a plurality of rollers at predetermined intervals so that the container V is movable, and moved up and down in parallel to the foot baseplate;
at least a pair of guides installed in parallel up and down at corner parts of the elevation plate;
an actuator configured to enable the elevation plate to move up and down along the guides; and
turn-over means installed on one side of the foot baseplate and configured to grasp and turn over the container V that is raised up.

16. The movable metal separator method according to claim 15, wherein the actuator comprises:
a driving motor installed in the base, and
chain units fixed to the elevation plate and chain-driven by the driving motor or sheers members installed between the base and the elevation plate and a hydraulic or pneumatic cylinder for driving the sheers members.

17. The movable metal separator method according to claim 15, wherein the turn-over means comprises:
a pivot installed so that the pivot is directed toward a center of the container V;
a forward/backward driving motor installed in the foot baseplate and configured to rotate the pivot; and
a pair of sheers members installed at an end of the pivot so that the sheers members face each other and operated by respective cylinders in opposite directions.

18. The movable metal separator method according to claim 15, wherein the automatic elevation means further comprises an auxiliary conveyer installed at a bottom so that the auxiliary conveyer is placed on a line extended from the plurality of rollers and configured to convey the containers V.

19. The movable metal separator method according to claim 1, wherein the ball mill further comprises an air inflow path provided between the ball mill and the hopper at a predetermined interval on an inlet side of the ball mill to which the hopper is coupled.

20. The movable metal separator method according to claim 19, wherein the air inflow path is formed to have an interval smaller than a diameter of a ball used in the ball mill.
